(19) United States
(12) Patent Application Publication
(10) Pub. No.: US 2004/0119878 A1
(43) Pub. Date: Jun. 24, 2004

(54) Electronic flash control

(76) Inventor: Satoshi Okamura, Kanagawa (JP)

Correspondence Address: ROBIN BLECKER & DALEY, 2ND FLOOR, 330 MADISON AVENUE, NEW YORK, NY, 10017, US

(21) Appl. No.: 10/728,315

(22) Filed: Dec. 4, 2003

(30) Foreign Application Priority Data
Dec. 10, 2002 (JP) 2002-358599

(51) Int. Cl. H04N 5/222

(52) U.S. Cl. 348/371

(57) ABSTRACT

An irradiation angle that prevails at the time of a light emission from an electronic flash is controlled in a digital image sensing apparatus having an optical zoom function and an electronic zoom function. First, zoom magnification is specified, then focal length information for the optical zoom function and view-angle scaling information for the electronic zoom function are generated based upon the indicated zoom magnification, and the irradiation angle of the electronic flash is decided based upon the focal length information and view-angle scaling information.

### FIELD OF THE INVENTION

This invention relates to electronic flash control and, more particularly, to control of an electronic flash capable of changing the irradiation angle at the time of the light emission in a digital image sensing device having a zoom function.

### BACKGROUND OF THE INVENTION

There are electronic flashes that can change the angle of irradiation at the time of a light emission. If such an electronic flash is used, the electronic flash is caused to emit light at the optimum irradiation angle, even when the focal length has changed owing to use of an optical zoom function, by causing the irradiation angle to work in operative association with the focal length of the optical zoom. This makes it possible to suppress needless flash illumination of areas outside the desired photographic scene.

An electronic zoom technique is known for use in video cameras or electronic still cameras. According to such a technique, interpolation or downsampling processing is applied to a signal that has been read out of an image sensing device, or an image signal is written from a signal processing circuit to a memory as image signal data and this data is subjected to interpolation or downsampling processing, thereby further enlarging or reducing the picture from the telephoto limit or wide-angle limit of the optical zoom to change the field angle of the scene.

FIG. 4 is a diagram illustrating an example of the structure of a conventional electronic still camera having an electronic flash capable of changing the irradiation angle, an optical zoom and an electronic zoom, the latter of which is implemented by memory control.

As shown in FIG. 4, the camera includes an image forming lens 401; a zoom lens 402; a diaphragm 412; an image sensing device 403 having a photoelectric conversion function; a signal processing circuit 404 for generating a video signal from an electric signal output by the image sensing device 403 and for reading and writing data, which is generated from the video signal, to and from a memory circuit, described later; a zoom key 405; a system control circuit 406 for generating zoom information, namely key on/off state, zoom direction and amount of change, from the result of operation of th zoom key 405, and for generating focal length information for the optical zoom and view-angle scaling information for the electronic zoom from the generated zoom information; a zoom-lens control circuit 407; an electronic flash 410 that is capable of setting the irradiation angle to any value at the time of the light emission; an electronic-flash control circuit 411 for outputting an irradiation-angle control value, which conforms to the focal-length information, to the electronic flash 410; a memory circuit 409 for retaining a video signal from the signal processing circuit 404; and a memory control circuit 408 for subjecting the video signal in the memory circuit 409 to electronic zoom processing that conforms to the view-angle scaling ratio.

Entrant light that has passed through a group of lenses is photoelectronically converted by the image sensing device 403, and the signal processing circuit 404 generates an image signal from the output of the image sensing device 403. The signal processing circuit 404 outputs this image signal to the memory circuit 409. Information indicative of operation of the zoom key 405 is input to the system control circuit 406. On the basis of the operation information from the zoom key 405, the system control circuit 406 generates zoom information indicating whether the key has b en pressed, whether the operation is for shifting zoom in the telephoto direction or wide-angle direction, and the degree of the change entered.

Reference will now be had to FIG. 5 to describe the operation of optical and electronic zoom control and the operation of electronic-flash control in the system control circuit 406.

The system control circuit 406 holds the immediately preceding focal length information. Operating information indicative of the on/off state of the zoom key 405, the direction of operation and the amount of change is input to the system control circuit 406 from the zoom key 405.

First, at step S501 in FIG. 5, the system control circuit 406 discriminates the on/off state of the zoom key 405. If the result of discrimination is that the zoom key 405 is ON, control proceeds to step S502. On the other hand, if the result of discrimination is that the zoom key 405 is OFF, focal length information identical with that of the immediately preceding information is output and control proceeds to step S503.

Next, at step S502, by taking into consideration the operating direction and amount of change from the zoom key 405, the focal length information being retained is subjected to updating and the updated information is output, after which control proceeds to step S503.

It is determined at step S503 whether the current focal length and optical telephoto limit are equal. Control proceeds to step S504 if the two are found to be equal at step S503 and to step S505 if the two are found to be different at step S503.

View-angle scaling information for the electronic zoom is generated at step S504 from the operating direction and amount of change indicated by the zoom key 405, after which control proceeds to step S506. At step S505, on the other hand, view-angle scaling information indicating a 1:1 view-angle scaling ratio is generated because the desired zoom magnification can be achieved solely by the optical zoom. Control then proceeds to step S506.

At step S506, an irradiation-angle control value for controlling the irradiation angle of the electronic flash 410 is generated based on the focal length information, after which control proceeds to step S507. Here the irradiation-angle control value is output to the electronic flash 410. Then, at step S508, the focal length information just obtained is stored, irrespective of the on/off state of zoom key 405, and control returns to step S501.

Thus, focal length information, which is for obtaining a control value for controlling the focal length of th zoom lens 402 and a control value for controlling the irradiation angle of the electronic flash 410, is generated from the zoom information. Furthermore, view-angle scaling information is generated from the focal length information and is input to the memory control circuit 408. On the basis of the focal length information output from the system control circuit 406, the zoom-lens control circuit 407 controls the focal length of the zoom lens 402 and implements the optical zoom function. On the basis of the view-angle scaling information that is output from the system control circuit 406, the memory control circuit 408 enlarges the video signal within the memory circuit 409, thus executes electronic zoom processing. Further, the electronic-flash control circuit 411 outputs the irradiation-angle control value, which has been generated on the basis of the focal length information, to the electronic flash 410 and controls the irradiation angle at the time of the light emission.

Thus, if the zoom key is operated in the telephoto direction from the state in which the focal length of the zoom lens 402 is at the optical wide-angle limit in the above-described electronic still camera, the focal length changes and the photographic image is enlarged. If the zoom key is further operated in the telephoto direction and the zoom key still continues to be operated in the same direction even after the optical telephoto limit is attained, the view-angle scaling ratio changes and the photographic image is enlarged by the electronic zoom function.

In a conventional electronic still camera having both optical and electronic zoom functions, irradiation-angle control of the electronic flash 410 is performed solely in operative association with the focal length information of the optical zoom. Therefore, as shown in FIG. 7, in the zoom area from the wide-angle limit to the telephoto limit of the optical zoom (this area shall be referred to as an “optical zoom zone” below), the irradiation angle of the electronic flash 410 is controlled appropriately with regard to the change in zoom position, whereby a suitable light emission is achieved without waste with regard to the view angle of the displayed image. However, after the optical zoom zone is surpassed and a transition is made to a zoom area (referred to as an “electronic zoom zone” below) in which the view-angle scaling ratio is changed by the electronic zoom function, the irradiation angle of the electronic flash 410 is left unchanged at the irradiation angle corresponding to the telephoto limit of the optical zoom and light is projected into an area broader than the view angle of the displayed image obtained by the lectronic zoom. As a consequence, a wasteful light emission is produced. When a light emission is made in the electronic zoom zone, therefore, a problem which arises is that the charging voltage of the electronic flash 410 is wasted.

### SUMMARY OF THE INVENTION

The present invention has been made in consideration of the above situation and its object is to so arrange it that the light emission of an electronic flash in an electronic still camera can be controlled efficiently without waste not only in an optical zoom zone but also in an electronic zoom zone.

According to the present invention, the foregoing object is attained by providing a digital image sensing apparatus having an optical zoom function and an electronic zoom function, comprising:

a controller that controls an electronic flash which can change irradiation angle at the time of a light emission;

a zoom key that indicates zoom magnification;

a control information generating unit that generates first control information for the optical zoom function and second control information for the electronic zoom function based upon the zoom magnification indicated by the zoom key; and

a decision unit that decides the irradiation angle of the electronic flash based upon the first control information and the second control information.

According to the present invention, the foregoing object is attained by providing a method of controlling an electronic flash which can change irradiation angle at the time of a light emission in a digital image sensing apparatus having an optical zoom function and an electronic zoom function, comprising:

indicating a zoom magnification;

generating first control information for the optical zoom function for the optical zoom function and second control information for the electronic zoom function based upon the zoom magnification indicated; and

deciding the irradiation angle of the electronic flash based upon the first control information and the second control information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the structure of an electronic still camera according to an embodiment of the present invention;

FIG. 2 is a flowchart illustrating processing for zoom control and light-emission control of an electronic still camera according to a first embodiment of the present invention;

FIG. 3 is a flowchart illustrating processing for zoom control and light-emission control of an electronic still camera according to a second embodiment of the present invention;

FIG. 4 is a block diagram illustrating the structure of a conventional electronic still camera;

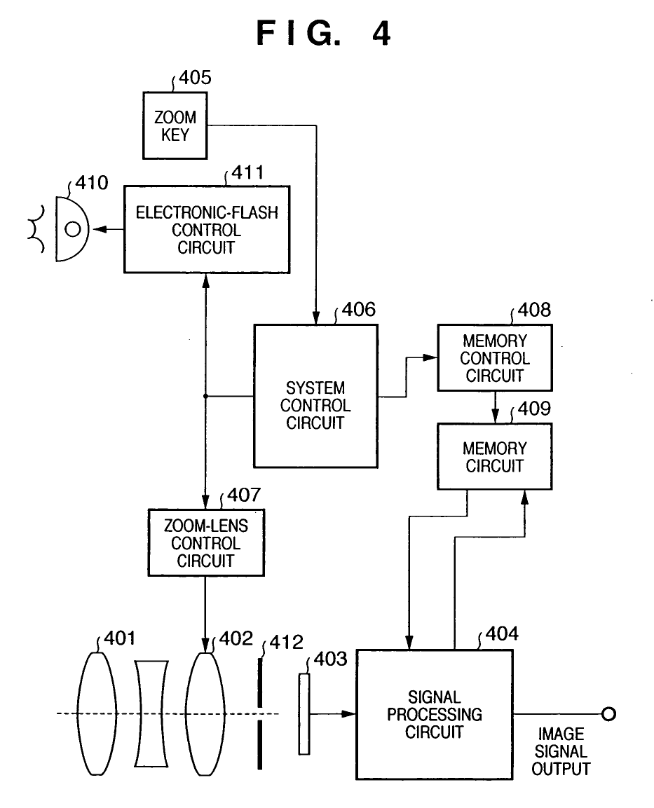

FIG. 5 is a flowchart illustrating processing for conventional zoom control and light-emission control of an electronic still camera;

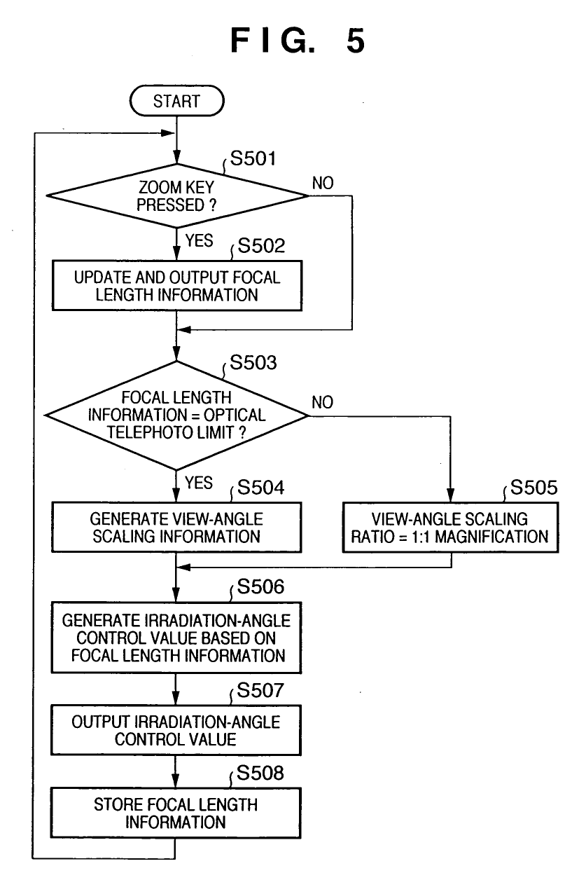

FIG. 6 is a diagram illustrating a change in the irradiation angle of an electronic flash in an electronic still camera according to an embodiment of the present invention; and

FIG. 7 is a diagram illustrating a change in the irradiation angle of an electronic flash in a conventional electronic still camera.

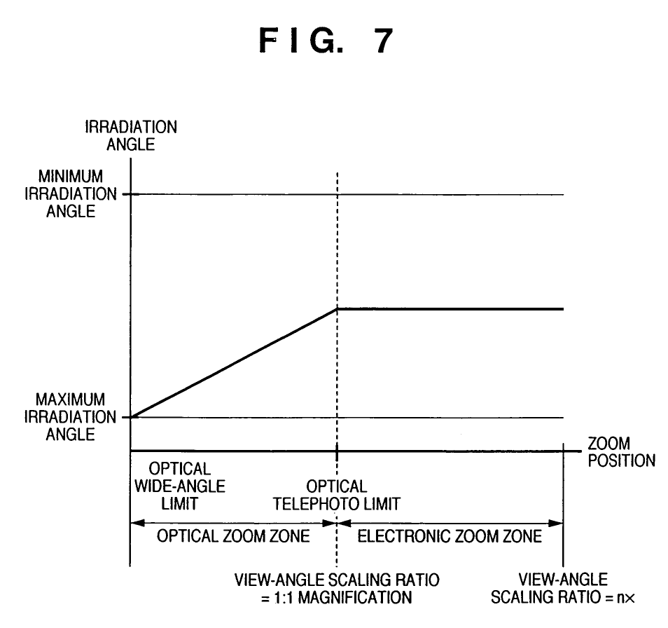

### DETAILED DESCRIPTION OF THE PREFERRED EMBODIMENTS

Preferred embodiments of the present invention will be described in detail in accordance with the accompanying drawings.

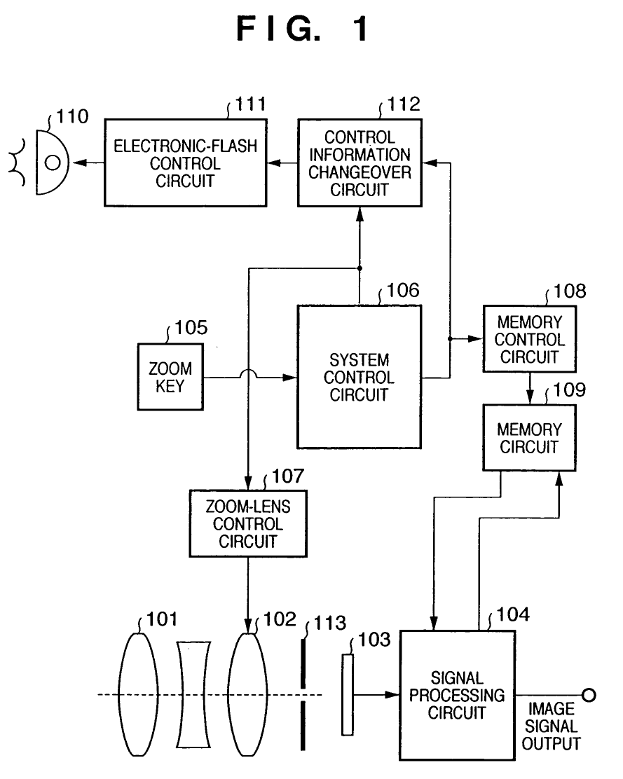

FIG. 1 is a block diagram illustrating the structure of an electronic still camera according to an embodiment of the present invention.

As shown in FIG. 1, the electronic still camera includes an image forming lens 101 for forming an image of entrant light on an image sensing device, described later; a zoom lens 102; a diaphragm 113; an image sensing device 103 for photoelectronically converting the entrant light; a signal processing circuit 104 for generating an image signal from an electric signal output by the image sensing device 103 and for reading and writing data, which is generated from the image signal, to and from a memory circuit, described later; a memory circuit 109 for retaining data which is generated from the image signal; a memory control circuit 108 for subjecting data in the memory circuit 109 to enlarging zoom processing conforming to view-angle scaling information that has entered from a system control circuit 106, described later; a zoom key 105; a system control circuit 106 for generating zoom information, namely key on/off state, zoom direction and amount of change, from the result of operation of the zoom key 105, and for generating focal length information and view-angle scaling information from the generated zoom information; a control information changeover circuit 112 for analyzing the focal length information and the view-angle scaling information that is output from the system control circuit 106 and changing between generation of irradiation-angle control value of the electronic flash based on the focal length information and generation of irradiation-angle control value based on the view-angle scaling information in accordance with the analyzed result; a zoom-lens control circuit 107 for driving the zoom lens 102; an electronic flash 110; and an electronic-flash control circuit 111 for controlling the irradiation angle of the electronic flash 110 based upon the entered irradiation-angle control value.

(First Embodiment)

The operation of the electronic still camera according to a first embodiment of the present invention will now be described.

The operation of the first embodiment will be described taking as an example a case where the zoom key 105 has been operated in the telephoto direction.

In an optical zoom zone [a zone between the wide-angle limit of the optical zoom (referred to as the “optical wide-angle limit” below) and the telephoto limit of the optical zoom (referred to as the “optical telephoto limit” below)], focal length information that has been output from the system control circuit 106 is input to the zoom-lens control circuit 107, which proceeds to control the position of the zoom lens 102 based upon the entered focal length information. Further, in the optical zoom zone, the system control circuit 106 generates view-angle scaling information indicative of 1:1 magnification and outputs this information to the memory control circuit 108 and control information changeover circuit 112. As a result, the memory control circuit 108 applies processing, which is for achieving 1:1 view-angle magnification, to the image signal in the memory circuit 109 obtained upon changing the view angle by the optical zoom function. In other words, enlargement processing is not applied to the data in the memory circuit 109.

Meanwhile, the focal length information and view-angle scaling information are also input to the control information changeover circuit 112. Since the focal length information has a value indicating the focal length on the wide-angle side with respect to the optical telephoto limit in the optical zoom zone, the control information changeover circuit 112 generates an irradiation-angle control value from the focal length information. Accordingly, the electronic-flash control circuit 111 performs control of the electronic flash 110 by an irradiation-angle control value derived from the focal length information. In other words, in the optical zoom zone, the irradiation angle of the electronic flash 110 is controlled in operative association with the focal length information.

If the zoom key 105 is operated further in the telephoto direction beyond the optical telephoto limit and the electronic zoom zone is reached, operation is as follows:

Since the focal length information that is output from the system control circuit 106 takes on a value at the optical telephoto limit in the electronic zoom zone, the zoom lens 102 halts at the optical telephoto limit in this zone. Meanwhile, information corresponding to the amount of change in zoom in the zoom information is generated by the system control circuit 106 as the view-angle scaling information, which now is not 1:1 magnification. The generated view-angle scaling information is input to the memory control circuit 108, which proceeds to apply enlargement processing that is based upon the view-angle scaling information to the image signal, which is being retained in the memory circuit 109, obtained at the optical zoom magnification of the optical telephoto limit. As a result, an image signal whose display picture has been enlarged is output from the signal processing circuit 104.

In a case where the focal length information is equal to the optical telephoto limit, on the other hand, the control information changeover circuit 112 generates the irradiation-angle control value based on the view-angle scaling information. Accordingly, the electronic-flash control circuit 111 performs control of the electronic flash 110 by an irradiation-angle control value derived from the view-angle scaling information. In other words, in the electronic zoom zone, the irradiation angle of the electronic flash 110 is controlled in operative association with the view-angle scaling information.

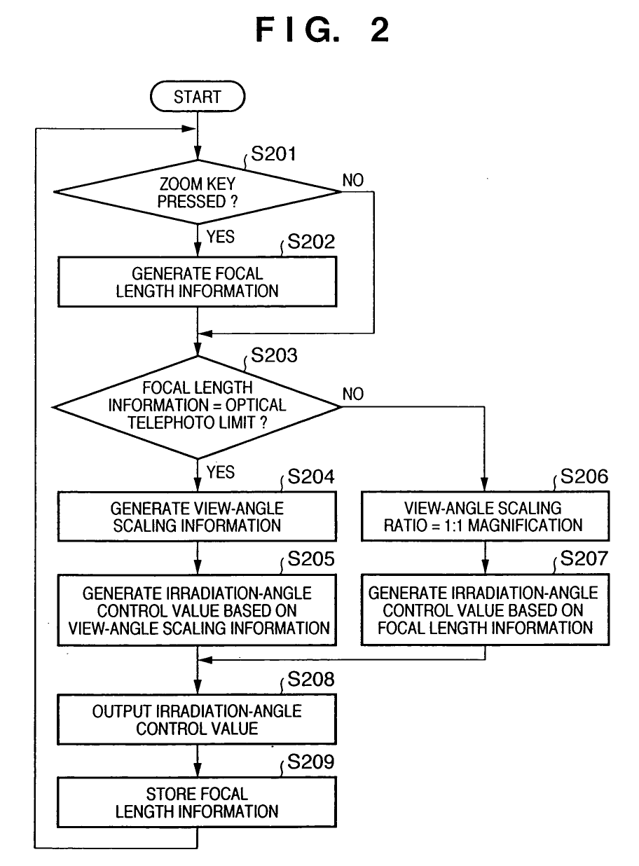

The zoom information and the operation of the system control circuit 106 and control information changeover circuit 112 will now be described with reference to the flowchart of FIG. 2.

The system control circuit 106 holds the immediately preceding focal length information. Further, operating information indicative of the on/off state of the zoom key 105, the direction of operation and the amount of change is input to the system control circuit 106 from the zoom key 105.

First, at step S201 in FIG. 2, the system control circuit 106 discriminates the on/off state of the zoom key 105. If the result of discrimination is that the zoom key 105 is ON, control proceeds to step S202. On the other hand, if the result of discrimination at step S201 is that the zoom key 105 is OFF, focal length information identical with that of the immediately preceding information is output and control proceeds to step S203.

Next, at step S202, by taking into consideration the operating direction and amount of change from the zoom key 105, the focal length information being retained is subjected to updating and the updated information is output, after which control proceeds to step S203.

It is determined at step S203 whether the current focal length and optical telephoto limit are equal. Control proceeds to step S204 if the two are found to be equal (i.e., in case of the electronic zoom zone) and to step S206 if the two are found to be different (i.e., in case of the optical zoom zone).

Next, view-angle scaling information is generated at step S204 from the operating direction and amount of change indicated by the zoom key 105, after which control proceeds to step S205. At step S205, an irradiation-angle control value for controlling the irradiation angle of the electronic flash 110 is generated based on the view-angle scaling information, after which control proceeds to step S208.

On the other hand, view-angle scaling information indicating a 1:1 view-angle scaling ratio is generated at step S206 because the desired zoom magnification can be achieved solely by the optical zoom. Control then proceeds to step S207. Here the control information changeover circuit 112 generates an irradiation-angle control value, which controls the irradiation angle of the electronic flash 110, based on the focal length information. Control then proceeds to step S208.

At step S208, the electronic-flash control circuit 111 outputs the irradiation-angle control value, which has been generated by the control information changeover circuit 112, to the electronic flash 110. Then, at step S209, the focal length information just obtained is stored, irrespective of the on/off state of zoom key 105, and control returns to step S201.

In accordance with the first embodiment, as described above, control of the irradiation angle of the electronic flash 110 in operative association with the focal length information is performed in the optical zoom zone, and control of the irradiation angle of the electronic flash 110 in operative association with the view-angle scaling information is performed in the electronic zoom zone, thereby making it possible to achieve control of irradiation angle that is best for the view angle of the image captured in both the optical zoom zone and electronic zoom zone. As a result, in still image sensing using the electronic flash 110, a waste-free light emission can be achieved with respect to the view angle of the display screen and, hence, it is possible to suppress loss of charging voltage in the electronic flash 110.

(Second Embodiment)

An electronic still camera according to a second embodiment of the present invention will now be described.

The operation of the second embodiment will be described taking as an example a case where the zoom key 105 has been operated in the telephoto direction.

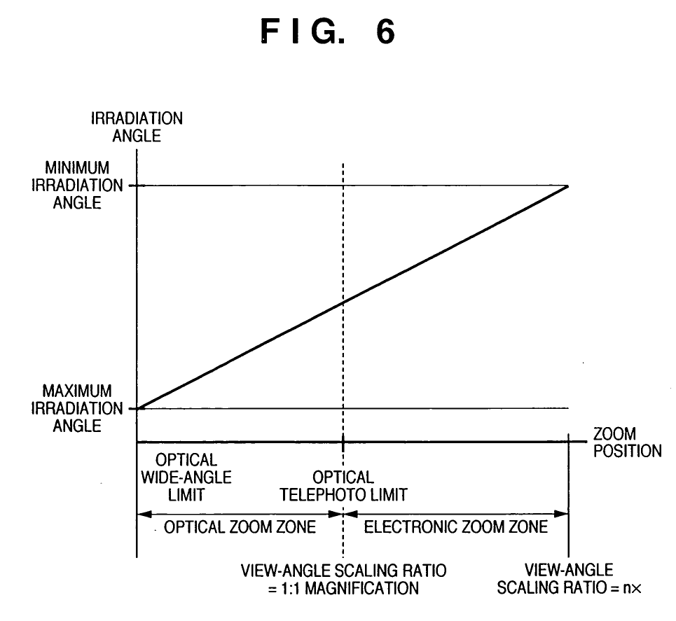

In the optical zoom zone shown in FIG. 6, focal length information that has been output from the system control circuit 106 is input to the zoom-lens control circuit 107, which proceeds to control the position of the zoom lens 102 based upon the entered focal length information. Further, in the optical zoom zone, the system control circuit 106 generates view-angle scaling information indicative of 1:1 magnification and outputs this information to the memory control circuit 108 and control information changeover circuit 112. As a result, the memory control circuit 108 applies processing, which is for achieving 1:1 view-angle magnification, to the image signal in memory circuit 109 obtained upon changing the view angle by the optical zoom function. In other words, enlargement processing is not applied to the data in the memory circuit 109.

Meanwhile, the focal length information and view-angle scaling information is also input to the control information changeover circuit 112. Since the view-angle scaling information is the 1:1 magnification value in the optical zoom zone, the control information changeover circuit 112 generates an irradiation-angle control value from the focal length information. Accordingly, the electronic-flash control circuit 111 performs control of the electronic flash 110 by an irradiation-angle control value derived from the focal length information. In other words, in the optical zoom zone, the irradiation angle of the electronic flash 110 is controlled in operative association with the focal length information.

If the zoom key 105 is operated further in the telephoto direction beyond the optical telephoto limit and the electronic zoom zone is reached, operation is as follows:

Since the focal length information that is output from the system control circuit 106 takes on a value at the optical telephoto limit in the electronic zoom zone, the zoom lens 102 halts at the optical telephoto limit in this zone. Meanwhile, information corresponding to the amount of change in zoom in the zoom information is generated by the system control circuit 106 as the view-angle scaling information, which now is not 1:1 magnification. The generated view-angle scaling information is input to the memory control circuit 108, which proceeds to apply enlargement processing that is based upon the view-angle scaling information to the image signal, which is being retained in the memory circuit 109, obtained at the optical zoom magnification of the optical telephoto limit. As a result, an image signal whose display picture has been enlarged is output from the signal processing circuit 104.

In a case where view-angle scaling information is a value greater than 1:1 magnification, the control information changeover circuit 112 generates the irradiation-angle control value based on the view-angle scaling information. Accordingly, the electronic-flash control circuit 111 performs control of the electronic flash 110 by an irradiation-angle control value derived from the view-angle scaling information. In other words, in the electronic zoom zone, the irradiation angle of the electronic flash 110 is controlled in operative association with the view-angle scaling information.

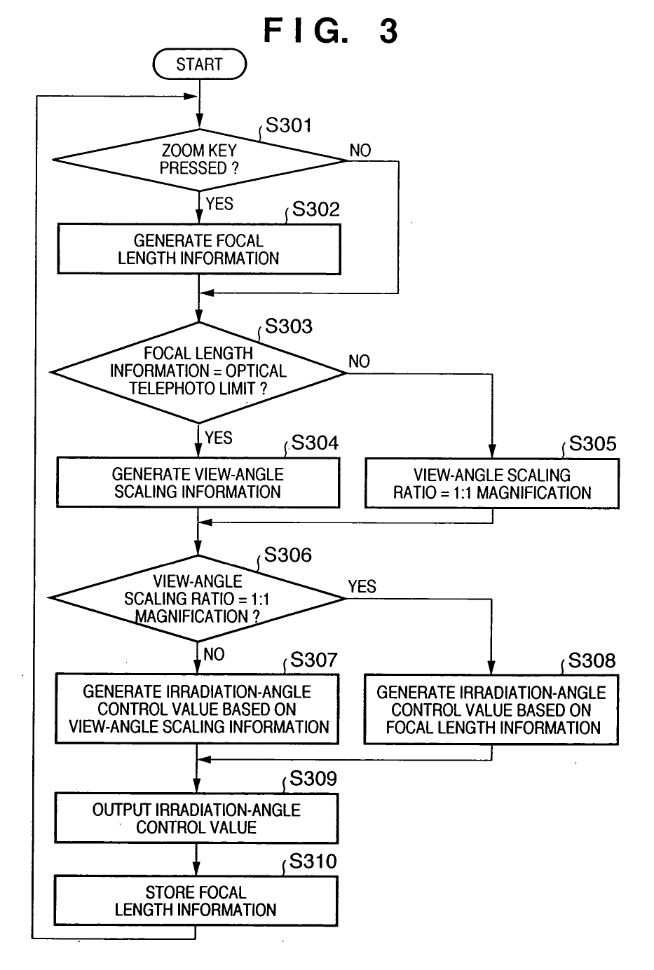

The zoom information and the operation of the system control circuit 106 and control information changeover circuit 112 will now be described with reference to the flowchart of FIG. 3.

The system control circuit 106 holds the immediately preceding focal length information. Further, operating information indicative of the on/off state of the zoom key 105, the direction of operation and the amount of change is input to the system control circuit 106 from the zoom key 105.

First, at step S301 in FIG. 3, the system control circuit 106 discriminates the on/off state of the zoom key 105. If the result of discrimination is that the zoom key 105 is ON, control proceeds to step S302. On the other hand, if the result of discrimination at step S301 is that the zoom key 105 is OFF, focal length information identical with that of the immediately preceding information is output and control proceeds to step S303.

Next, at step S302, by taking into consideration the operating direction and amount of change from the zoom key 105, the focal length information being retained is subjected to updating and the updated information is output, after which control proceeds to step S303.

It is determined at step S303 whether the current focal length and optical telephoto limit are equal. Control proceeds to step S304 if the two are found to be equal (i.e., in case of the electronic zoom zone) and to step S305 if the two are found to be different (i.e., in case of the optical zoom zone).

Next, view-angle scaling information is generated at step S304 from the operating direction and amount of change indicated by the zoom key 105, after which control proceeds to step S306. View-angle scaling information indicating a 1:1 view-angle scaling ratio is generated at step S305 because the desired zoom magnification can be achieved solely by the optical zoom.

Next, at step S306, it is determined whether the view-angle scaling information is a value equivalent to 1:1 magnification. Control proceeds to step S308 if the result of the determination is 1:1 magnification and to step S307 if the result of the determination is not 1:1 magnification.

At step S307, the control information changeover circuit 112 generates an irradiation-angle control value, which is for controlling the irradiation angle of the electronic flash 110, based on the view-angle scaling information, after which control proceeds to step S309. At step S308, on the other hand, the control information changeover circuit 112 generates an irradiation-angle control value, which is for controlling the irradiation angle of the electronic flash 110, based on the focal length information, after which control proceeds to step S309.

At step S309, the electronic-flash control circuit 111 outputs the irradiation-angle control value, which has been generated by the control information changeover circuit 112, to the electronic flash 110. Then, at step S310, the focal length information just obtained is stored, irrespective of the on/off state of zoom key 105, and control returns to step S301.

In accordance with the second embodiment, as described above, control of the irradiation angle of the electronic flash 110 in operative association with the focal length information is performed in the optical zoom zone, and control of the irradiation angle of the electronic flash 110 in operative association with the view-angle scaling information is performed in the electronic zoom zone, thereby making it possible to achieve control of irradiation angle that is best for the view angle of the image captured in both the optical zoom zone and electronic zoom zone. As a result, in still photography using the electronic flash 110, a waste-free light emission can be achieved with respect to the view angle of the display screen and, hence, it is possible to suppress loss of charging voltage in the electronic flash 110.

(Other Embodiment)

In the first and second embodiments, the present invention is described in a case where it is applied to a digital still camera. However, the present invention is not limited to this application. For example, the present invention is applicable to various image sensing devices having an optical zoom function and an electronic zoom function for capturing images using an electronic flash in which the irradiation angle can be changed. An example is one where a still image is captured by a digital video camera.

Further, in the first and second embodiments, a case where an electronic zoom is implemented solely in an area where the telephoto limit of the optical zoom is exceeded has been described. However, this does not impose a limitation upon the present invention. The invention can be applied in similar fashion even in a case where a change in angle of view ascribable to electronic zoom is carried out with regard to an area where the wide-angle limit of the optical zoom is exceeded.

In this case, the irradiation angle of the electronic flash is decided based upon the view-angle scaling information for the electronic zoom in the area where the wide-angle limit of the optical zoom is exceeded. More specifically, the irradiation angle is decided in such a manner that a wider area will be irradiated.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. A digital image sensing apparatus having an optical zoom function and an electronic zoom function, comprising:
a controller that controls an electronic flash which can change irradiation angle at the time of a light emission;
a zoom key that indicates zoom magnification;
a control information generating unit that generates first control information for the optical zoom function and second control information for the electronic zoom function based upon the zoom magnification indicated by said zoom key; and
a decision unit that decides the irradiation angle of the electronic flash based upon the first control information and the second control information.

2. The apparatus according to claim 1, wherein said decision unit decides the irradiation angle based upon the second control information in a case where the first control information indicates a telephoto limit or wide-angle limit of the optical zoom, and decides the irradiation angle based upon the first control information in a case other than the telephoto limit or wide-angle limit.

3. The apparatus according to claim 1, wherein said decision unit decides the irradiation angle based upon the first control information in a case where the second control information indicates 1:1 magnification of the electronic zoom, and decides the irradiation angle based upon the second control information in a case other than 1:1 magnification.

4. The apparatus according to claim 1, wherein said decision unit narrows the irradiation angle as the zoom magnification indicated by said zoom key rises.

5. A method of controlling an electronic flash which can change irradiation angle at the time of a light emission in a digital image sensing apparatus having an optical zoom function and an electronic zoom function, comprising:
indicating a zoom magnification;
generating first control information for the optical zoom function for the optical zoom function and second control information for the electronic zoom function based upon the zoom magnification indicated; and
deciding the irradiation angle of the electronic flash based upon the first control information and the second control information.

6. The method according to claim 5, wherein in deciding the irradiation angle, the irradiation angle is decided based upon the second control information in a case where the first control information indicates a telephoto limit or wide-angle limit of the optical zoom, and the irradiation angle is decided based upon the first control information in a case other than the telephoto limit or wide-angle limit.

7. The method according to claim 5, wherein in deciding the irradiation angle, the irradiation angle is decided based upon the first control information in a case where the second control information indicates 1:1 magnification of the electronic zoom, and the irradiation angle is decided based upon the second control information in a case other than 1:1 magnification.

8. The method according to claim 5, wherein in deciding the irradiation angle, the irradiation angle is narrowed as the indicated zoom magnification rises.

9. A storage medium, which is readable by an information processing apparatus, storing a program including program codes capable of implementing the control method set forth in claim 5, said program being executable by the information processing apparatus.
